(19) United States
(12) Patent Application Publication
(10) Pub. No.: US 2025/0346762 A1
(43) Pub. Date: Nov. 13, 2025

(54) SILICONE FOAM WITH IMPROVED SOUND ABSORPTION

(71) Applicant: ROGERS CORPORATION, Chandler, AZ (US)

(72) Inventors: Kshitish A. Patankar, Naperville, IL (US); Katherine Vuong, Chicago, IL (US); Kenneth Mazich, Chicago, IL (US)

(21) Appl. No.: 19/199,618

(22) Filed: May 6, 2025

Related U.S. Application Data
(60) Provisional application No. 63/643,976, filed on May 8, 2024.

(51) Int. Cl. C08L 83/10; C08G 77/00; C08G 77/08; C08G 77/442; C08J 9/00; C08J 9/12; C08K 3/22

(52) U.S. Cl. CPC C08L 83/10; C08G 77/08; C08G 77/442; C08G 77/80; C08J 9/0061; C08J 9/0066; C08J 9/125; C08K 3/22; C08G 2110/0041; C08G 2350/00; C08J 2205/05; C08J 2383/04; C08J 2461/10; C08J 2461/28; C08K 2003/2224; C08K 2003/2227; C08K 2201/005

(57) ABSTRACT

A sound-absorbing material includes an open-cell, filled silicone foam having a density of less than 155 kg/m³ and a porosity of at least 70%, wherein the silicone foam has an average cell size of less than 2300 micrometers, determined in a direction parallel to the rise direction, and an average cell size of less than 800 micrometers, determined in a direction perpendicular to the rise direction, each determined by optical microscopy.

### CROSS REFERENCE TO RELATED APPLICATION

This application claims the benefit of U.S. Application No. 63/643,976, filed May 8, 2024, which is incorporated by reference in its entirety herein.

### BACKGROUND

This application is directed to silicone foams with improved sound absorption properties, and methods for the manufacture thereof.

Sound-absorbing materials are useful in a variety of settings. For example, in transportation, sound-absorbing materials can be placed around the engine of a vehicle or in or around the cabin of a vehicle to absorb certain frequencies, especially frequencies of less than 2000 hertz. In the medical field, sound absorption can be important in conjunction with various instruments including, for example, encapsulation of medical saws or continuous positive airway pressure (CPAP) machines. Sound-absorbing materials also find use in construction industries.

Previous methods of providing sound-absorbing materials include increasing the thickness or weight of the sound-absorbing material. However this can have the undesired effect of adding weight or bulk to the material, which can hamper its utility in some applications.

There accordingly remains a continuing need in the art for improved sound absorption materials. It would be particularly advantageous to provide materials which have excellent sound absorption properties, specifically in a low frequency range (e.g., up to 500 hertz), and which are also lightweight.

### SUMMARY

A sound-absorbing material comprises an open-cell, filled silicone foam having a density of less than 155 kg/m³; a porosity of at least 70%; wherein the silicone foam has an average cell size of less than 2300 micrometers, determined in a direction parallel to a rise direction of the foam, and an average cell size of less than 800 micrometers, determined in a direction perpendicular to a rise direction of the foam, each determined by optical microscopy.

A method of making an open-cell, filled silicone foam for use as a sound-absorbing material comprises curing a curable composition in the presence of methylolated melamine formaldehyde to provide the silicone foam, preferably wherein the methylolated melamine formaldehyde is present in an amount of 0.1 to 5 weight percent, or 0.1 to 1 weight percent, or 0.1 to 0.75 weight percent, based on the total weight of the curable composition; or phenol-formaldehyde resole to provide the silicone foam, preferably wherein the phenol-formaldehyde resole is present in an amount of 0.05 to 2 weight percent, or 0.06 to 1.5 weight percent, or 0.07 to 0.1.1 weight percent, based on the total weight of the curable composition.

A method of making an open-cell, filled silicone foam for use as a sound-absorbing material comprises curing a curable composition having a molar ratio of hydride groups to a sum of alkenyl and hydroxyl groups of 1.1:1 to 1.5:1 to provide the silicone foam.

The above described and other features are exemplified by the following figures and detailed description.

### BRIEF DESCRIPTION OF THE DRAWINGS

The following figures represent exemplary embodiments.

FIG. 1 is a schematic, cross-sectional illustration of an aspect of a sound-absorbing material.

FIG. 2 shows a graph of frequency (hertz (Hz)) versus normalized acoustical absorption coefficient for the compositions of Comparative Example 1 and Examples 1-4.

FIG. 3 shows a graph of frequency (Hz) versus normalized acoustical absorption coefficient for the compositions of Comparative Example 1 and Examples 5 and 6.

FIG. 4 shows optical images of cross sections of foams parallel to the rise direction of the foam for Comparative Example 1 and Examples 2-4 and 6-7.

FIG. 5 shows optical images of cross sections of foams perpendicular to the rise direction of the foam for Comparative Example 1 and Examples 2-3 and 6-7.

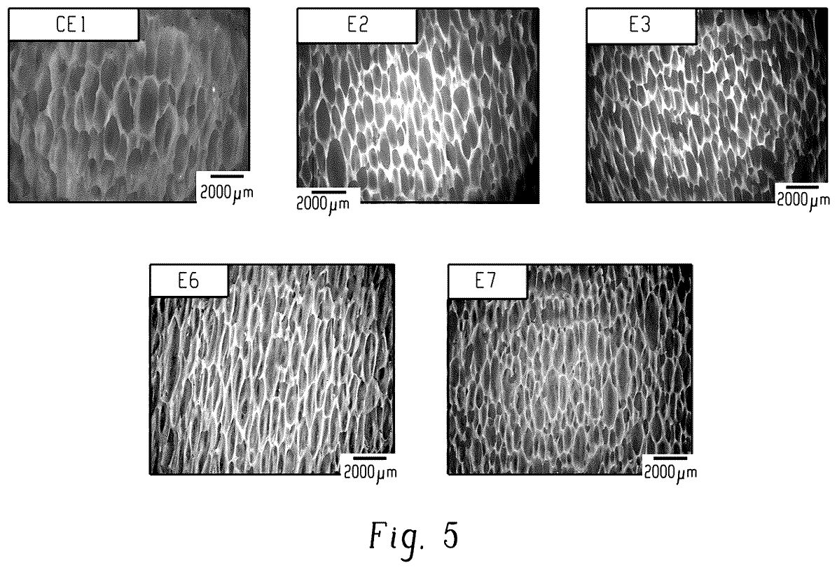

### DETAILED DESCRIPTION

The present inventors have found that the aforementioned technical challenges associated with sound absorbing materials can be addressed by a particular silicone foam. The silicone foam described herein is an open-celled, filled foam having a specific density, porosity, and pore size. In some aspects, the present inventors have unexpectedly found that particular hybrid foams including phenol-formaldehyde resins or melamine formaldehyde resins can provide further advantages. A significant improvement is therefore provided by the present disclosure.

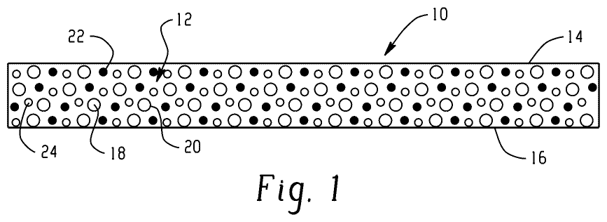

Accordingly, an aspect of the present disclosure is a sound-absorbing material. The sound-absorbing material comprises an open-cell, filled silicone foam. An aspect is shown in FIG. 1, in which a sound-absorbing material 10 comprises an open-cell, filled silicone foam layer 12 having a first outer surface 14 and an opposite second outer surface 16. Although shown as flat, one or both or all of the outer surfaces can be contoured to provide a better fit with an article configured to receive the sound-absorbing material. The sound-absorbing material 10 is filled and thus comprises a filler 22, 24. Filler 22 and filler 24 can be the same (i.e., the sound-absorbing material 10 comprises one type of filler) or filler 22 and filler 24 can be different (i.e., the sound-absorbing material 10 comprises two types of filler). Although two types of fillers are depicted in FIG. 1, one, two, or more types of fillers can be present in the filler composition, as discussed in further detail below.

The silicone foam is prepared by curing a curable composition comprising a particular combination of components. The relative amounts of each component in the curable composition can be adjusted to provide the desired properties of the cured material. The curable composition advantageously includes a particular combination of an alkenyl-containing component, a hydride-containing component, a cure catalyst, a filler composition, a blowing agent, and, optionally, methylolated melamine formaldehyde or phenol-formaldehyde resole.

The curable composition used to generate the silicone foam comprises an alkenyl-containing component. The alkenyl-containing component comprises an alkenyl-containing polyorganosiloxane. In an aspect, the alkenyl-containing component comprises an alkenyl-diterminated polyorganosiloxane. The alkenyl-diterminated polyorganosiloxane can be represented by the formula:

MₐD_{b}T_{c}Q_{d},
wherein the subscripts a, b, c, and d are zero or a positive integer, subject to the limitation that if subscripts a and b are both equal to zero, subscript c is greater than or equal to two; M has the formula R₃SiO_{1/2}; D has the formula R₂SiO_{2/2}; T has the formula RSiO_{3/2}; and Q has the formula SiO_{4/2}, wherein each R group independently represents hydrogen, terminally-substituted C₁₋₆ alkenyl groups, substituted and unsubstituted monovalent hydrocarbon groups having from 1 to 40, or 1 to 6 carbon atoms each, subject to the limitation that at least 1, for example, at least 2, of the R groups are alkenyl R groups. Suitable alkenyl R-groups are exemplified by vinyl, allyl, 1-butenyl, 1-pentenyl, and 1-hexenyl, with vinyl being particularly useful. The alkenyl group is bonded at the molecular chain terminals, i.e., an alkenyl-terminated polyorganosiloxane. As used herein, an alkenyl-diterminated polyorganosiloxane refers to a polyorganosiloxane wherein two of the chain ends are alkenyl groups. In an aspect, the alkenyl-diterminated polyorganosiloxane is a vinyl-diterminated polyorganosiloxane. As used herein, a vinyl group is a group having the formula —CH═CH₂, and a “substituted vinyl group” has the formula —CH═CR₂, where the R groups can be independently hydrogen or C₁₋₆ alkyl groups. The vinyl concentration in the alkenyl-terminated polyorganosiloxane can be, for example 0.001 to 3 weight percent, or 0.01 to 0.5 weight percent, or 0.01 to 0.15 weight percent, or 0.01 to 0.1 weight percent.

Other silicon-bonded organic groups in the alkenyl-terminated polyorganosiloxane, when present, are exemplified by substituted and unsubstituted monovalent hydrocarbon groups having from one to forty carbon atoms, for example, alkyl groups such as methyl, ethyl, propyl, butyl, pentyl, and hexyl; aryl groups such as phenyl, tolyl, and xylyl; aralkyl groups such as benzyl and phenethyl; and halogenated alkyl groups such as 3-chloropropyl and 3,3,3-trifluoropropyl. Methyl and phenyl are specifically useful.

The alkenyl-diterminated polyorganosiloxane can have straight chain, partially branched straight chain, branched-chain, or a network molecular structure, or can be a mixture of such structures. The alkenyl-diterminated polyorganosiloxane is exemplified by vinyl-endblocked polydimethylsiloxanes; vinyl-endblocked dimethylsiloxane-diphenylsiloxane copolymers; vinyl-endblocked dimethylsiloxane-methylphenylsiloxane copolymers; vinyl-endblocked dimethylsiloxane-methylphenylsiloxane-diphenylsiloxane copolymers; vinyl-endblocked dimethylsiloxane-methylphenylsiloxane copolymers; vinyl dimethylsiloxane-methylvinylsiloxane copolymers; vinyl-endblocked methylvinylsiloxane-methylphenylsiloxane copolymers; vinyl-endblocked dimethylsiloxane-methylvinylsiloxane-methylphenylsiloxane copolymers; dimethylvinylsiloxy-endblocked methylvinylpolysiloxanes; dimethylvinylsiloxy-endblocked methylvinylphenylsiloxanes; dimethylvinylsiloxy-endblocked dimethylvinylsiloxane-methylvinylsiloxane copolymers; dimethylvinylsiloxy-endblocked dimethylsiloxane-methylphenylsiloxane copolymers; dimethylvinylsiloxy-endblocked dimethylsiloxane-diphenylsiloxane copolymers; or a combination thereof. In a specific aspect, the alkenyl-diterminated polyorganosiloxane comprises a vinyl-diterminated polydimethylsiloxanc.

The alkenyl-diterminated polyorganosiloxane can have a viscosity of greater than 500 centipoise (cP). In an aspect, the alkenyl-diterminated polyorganosiloxane can have a viscosity of greater than 1,000 cP, or greater than 500 to 150,000 cP, or 1,000 to 150,000 cP 10,000 to 150,000 cP, or 50,000 to 150,000 cP, or 50,000 to 150,000 cP. In a specific aspect, the alkenyl-diterminated polyorganosiloxane comprises a vinyl-diterminated polydimethysiloxane having a viscosity of 1,000 to 10,000 cP, preferably a viscosity of 1,000 to 5,000 cP, or 1,000 to 3,000 cP. Combinations of more than one alkenyl-diterminated polyorganosiloxane are also contemplated.

The alkenyl-diterminated polyorganosiloxane can be present in the curable composition in an amount of 30 to 99.9 weight percent, based on the total weight of the curable composition. Within this range, the alkenyl-diterminated polyorganosiloxane can be present in the curable composition in an amount of 30 to 90 weight percent, or 30 to 70 weight percent, or 35 to 68 weight percent, or 35 to 65 weight percent, or 40 to 60 weight percent, or 45 to 55 weight percent, each based on the total weight of the curable composition.

The alkenyl-containing component of the curable composition can optionally further include an alkenyl-substituted MDQ polyorganosiloxane. As used herein, “MDQ polyorganosiloxane” refers to a polyorganosiloxane represented by the formula:

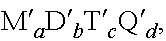

wherein the subscripts a, b, and d are each a positive integer and c is zero or a positive integer; M′ has the formula R₃SiO_{1/2}; D′ has the formula R₂SiO_{2/2}; T′ has the formula RSiO_{3/2}; and Q′ has the formula SiO_{4/2}, wherein each R group independently represents hydrogen, terminally-substituted C₁₋₆ alkenyl groups, substituted and unsubstituted monovalent hydrocarbon groups having from one to forty, or 1 to 6 carbon atoms each, subject to the limitation that at least 1, for example, at least 2, of the R groups are alkenyl R groups. Suitable alkenyl R-groups are exemplified by vinyl, allyl, 1-butenyl, 1-pentenyl, and 1-hexenyl, with vinyl being particularly useful. The alkenyl group can be bonded at the molecular chain terminals, in pendant positions on the molecular chain, or both. In a specific aspect, the alkenyl-substituted MDQ polyorganosiloxane is a vinyl-substituted MDQ polyorganosiloxane.

In an aspect, the alkenyl-substituted MDQ polyorganosiloxane can have an alkenyl content (e.g., a vinyl content) of 1 to 2.5 weight percent, or 2 to 2.5 weight percent, each based on the total weight of the MDQ polyorganosiloxane.

In an aspect, the alkenyl-substituted MDQ polyorganosiloxane can have a viscosity of greater than 500 cP, for example greater than 1,000 cP, or greater than 5,000 cP, or greater than 10,000 cP. In a specific aspect, the alkenyl-terminated polyorganosiloxane can have a viscosity of 5,000 to 20,000 cP, or 10,000 to 20,000 cP. Combinations of more than one MDQ polyorganosiloxanes are also contemplated.

In some aspects, the MDQ polyorganosiloxane can be provided in the form of a blend with a carrier fluid. Exemplary carrier fluids can include a polyorganosiloxane, for example comprising an alkenyl-diterminated polyorganosiloxane. The alkenyl-diterminated polyorganosiloxane can be as described above, and can be the same or different from the above-described alkenyl-diterminated polyorganosiloxane. In an aspect, the alkenyl-substituted MDQ can be provided in a carrier fluid comprising a third polyorganosiloxane comprising an alkenyl-diterminated polyorganosiloxane having an alkenyl content of 0.01 to 0.5 weight percent, and a number average molecular weight of 25,000 to 35,000 grams per mole, 65,000 to 75,000 grams per mole, or a combination thereof.

The MDQ polyorganosiloxane can be present in the curable composition in an amount of 0.5 to 25 weight percent, based on the total weight of the curable composition. Within this range, the MDQ polyorganosiloxane can be present in the curable composition in an amount of 1 to 20 weight percent, or 2 to 18 weight percent, or 5 to 15 weight percent, or 8 to 13 weight percent, each based on the total weight of the curable composition.

In addition to the alkenyl-containing component, the curable composition comprises a hydride-containing component. The hydride-containing component comprises a hydride-substituted polyorganosiloxane. The hydride-substituted polyorganosiloxane can have at least two silicon-bonded hydrogen atoms per molecule, and is generally represented by the formula:

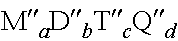

wherein the subscripts a, b, c, and d are zero or a positive integer, subject to the limitation that if subscripts a and b are both equal to zero, subscript c is greater than or equal to two; M″ has the formula R₃SiO_{1/2}; D″ has the formula R₂SiO_{2/2}; T″ has the formula RSiO_{3/2}; and Q″ has the formula SiO_{4/2}, wherein each R group independently represents hydrogen, substituted and unsubstituted monovalent hydrocarbon groups having from one to forty, or one to six carbon atoms each, subject to the limitation that at least two of the R groups are hydrogen. For example, each of the R groups of the polyorganosiloxane having at least two silicon-bonded hydrogen atoms per molecule are independently selected from hydrogen, methyl, ethyl, propyl, butyl, pentyl, hexyl, aryl, phenyl, tolyl, xylyl, aralkyl, benzyl, phenethyl, halogenated alkyl, 3-chloropropyl, 3,3,3-trifluoropropyl, or a combination thereof. Methyl and phenyl can be preferred.

The hydrogen can be bonded to silicon at the molecular chain terminals, in pendant positions on the molecular chain, or both. In an aspect, the hydrogens are substituted at terminal positions. In an aspect, at least 3 to 4 hydrogens are present per molecule. The hydrogen-containing polyorganosiloxane component can have straight chain, partially branched straight chain, branched-chain, cyclic, or network molecular structure, or can be a mixture of two or more different polyorganosiloxanes with the exemplified molecular structures.

The hydride-containing polyorganosiloxane can comprise, for example, trimethylsiloxy-endblocked methylhydrogenpolysiloxanes; trimethylsiloxy-endblocked dimethylsiloxane-methylhydrogensiloxane copolymers; trimethylsiloxy-endblocked methylhydrogensiloxane-methylphenylsiloxane copolymers; trimethylsiloxy-endblocked dimethylsiloxane-methylhydrogensiloxane-methylphenylsiloxane copolymers; dimethylhydrogensiloxy-endblocked dimethylpolysiloxanes; dimethylhydrogensiloxy-endblocked methylhydrogenpolysiloxanes; dimethylhydrogensiloxy-endblocked dimethylsiloxanes-methylhydrogensiloxane copolymers; dimethylhydrogensiloxy-endblocked dimethylsiloxane-methylphenylsiloxane copolymers; and dimethylhydrogensiloxy-endblocked methylphenylpolysiloxanes. In a specific aspect, the hydride-substituted polyorganosiloxane comprises a trimethylsiloxy-endblocked methylhydrogenpolysiloxane.

In an aspect, the silicone hydride-containing component can comprise silicon-bonded hydrogen atoms and an alkenyl group. In an aspect, the alkenyl group can be a vinyl group, and can be positioned at a chain end of the silicon-hydride containing component. In an aspect, no alkenyl groups are present on the hydride-containing silicone.

The silicone hydride-containing component can have a hydride content ranging from 0.01 to 10 percent by weight and a viscosity ranging from 10 to 10,000 centipoise at 25° C. In a specific aspect, the hydride-substituted polyorganosiloxane comprises a trimethylsiloxy-endblocked methylhydrogenpolysiloxane having a hydride content of 0.1 to 5 weight percent, or 0.5 to 2 weight percent, or 1 to 2 weight percent. In a specific aspect, the hydride-substituted polyorganosiloxane comprises a trimethylsiloxy-endblocked methylhydrogenpolysiloxane having a viscosity of 10 to 50 cP, or 10 to 30 cP, or 15 to 30 cP, or 20 to 30 cP. In yet another specific aspect, the hydride-substituted polyorganosiloxane comprises a trimethylsiloxy-endblocked methylhydrogenpolysiloxane having a hydride content of 0.1 to 5 weight percent, or 0.5 to 2 weight percent, or 1 to 2 weight percent and a viscosity of 10 to 50 cP, or 10 to 30 cP, or 15 to 30 cP, or 20 to 30 cP.

Combinations of hydride-containing polyorganosiloxanes are also contemplated by the present disclosure.

The hydride-substituted polyorganosiloxane component is used in an amount sufficient to cure the composition. For example, the alkenyl-containing component and the hydride-containing component can be present in a weight ratio of alkenyl-containing component:hydride-containing component of 10:1 to 30:1, or 13:1 to 30:1, or 13:1 to 25:1, or 13:1 to 20:1. In an aspect, the hydride-substituted polyorganosiloxane component can be used in a quantity that provides a molar ratio of hydride groups to a sum of alkenyl and hydroxyl groups of greater than or equal to 0.8:1 to less than or equal to 3, or 1:1 to 2:1, or 1.1:1 to 1.8:1, or 1.2:1 to 1.7:1, or 1.1:1 to 1.5:1, or 1.3:1 to 1.5:1.

In addition to the alkenyl-containing component and the hydride-containing component, the curable composition can further comprise one or more of a cure catalyst, a filler composition, and a blowing agent.

The cure catalyst can be a hydrosilylation-reaction catalyst. Effective catalysts promote the addition of silicon-bonded hydrogen onto alkenyl multiple bonds to accelerate cure. Such catalyst can include a noble metal, such as, for example, platinum, rhodium, palladium, ruthenium, iridium, or a combination thereof. The catalyst can also include a support material, such as activated carbon, aluminum oxide, silicon dioxide, polymer resin, or a combination thereof.

In an aspect, the cure catalyst can be present in amounts of up to 1,000 parts per million by weight (ppmw) of metal (e.g., platinum). In an aspect, the cure catalyst can be present in an amount of 1 to 500 ppmw, or 1 to 250 ppmw, or 1 to 100 ppmw, or 1 to 50 ppmw, or 5 to 50 ppmw, or 10 to 40 ppmw.

Platinum and platinum-containing compounds can be preferred, and include, for example platinum black, platinum-on-alumina powder, platinum-on-silica powder, platinum-on-carbon powder, chloroplatinic acid, alcohol solutions of chloroplatinic acid platinum-olefin complexes, platinum-alkenylsiloxane complexes and the catalysts afforded by the microparticulation of the dispersion of the catalyst in a polymer resin such as methyl methacrylate, polycarbonate, polystyrene, silicone, and the like. A combination of different catalysts can also be used. When a platinum catalyzed system is used, poisoning of the catalyst can occur, which can cause formation of an uncured or poorly cured silicone composition that is low in strength. Additional platinum can be added, but when a large amount of platinum is added to improve cure, the pot life or working time can be adversely affected. Methyl vinyl (MviMvi) components can be used as a cure retardant, for example DOWSIL™ 1-2287 Cure Inhibitor from Dow Corning. Such materials bind the platinum at room temperature to prevent cure and hence, improve the working time, but release the platinum at higher temperatures to affect cure in the required period of time. The level of platinum and cure retardant can be adjusted to alter cure time and working time/pot life. When a higher platinum level is used, it is typically less than or equal to 100 ppmw, based on a total weight of the curable polyorganosiloxane composition. Within this range, the additional platinum concentration (i.e., the amount over that required) can be greater than or equal to 50 ppmw, or greater than or equal to 60 ppmw, based on the total weight of the curable composition. Also within this range, the additional platinum concentration can be less than or equal to 90 ppmw, or less than or equal to 80 ppmw, based on a total weight of the curable composition.

The cure retardant concentration (if a cure retardant is used) is less than or equal to 0.3 weight percent (wt %) of the total curable polyorganosiloxane composition. Within this range, the cure retardant concentration is greater than or equal to 0.005 wt %, or greater than or equal to 0.025 wt % based on the total weight of the curable polyorganosiloxane composition. Also within this range, the cure retardant concentration is less than or equal to 0.2 wt %, or less than or equal to 0.1 wt %, based on the total weight of curable composition and the required working time or pot life.

The open-cell, filled silicone foam comprises a filler composition. Thus the curable composition further comprises a filler composition. The filler composition can comprise one type of filler. In an aspect, the filler composition can comprise two or more different fillers. With further reference to FIG. 1, the filler composition can comprise two or more different fillers, 22, 24 distributed in the silicone foam layer. In an aspect, the filler composition can comprise a single filler 22 distributed within the silicone foam layer. The filler(s) can be distributed essentially uniformly, or as a gradient, for example increasing from a first outer surface 14 in the direction of second outer surface 16. As used herein, the phrase “disposed within” can mean that the filler composition is distributed within the matrix of the silicone foam layer as shown in FIG. 1. Further as used herein, the phrase “disposed within” can mean that the filler composition can be located within a pore 18 of the silicone foam layer, for example coating an inner surface 20 of the silicone foam layer, or located within the pore in particulate form. A portion of the number of pores in the silicone foam layer can contain the filler composition, or essentially all, or all of the pores can contain the filler composition. Each pore containing the filler composition can independently be partially filled, essentially fully filled, or fully filled.

The filler is preferably in a particulate form to allow easy incorporation into the silicone foam during manufacture thereof. As described above, the filler composition in particulate form can be located within the silicone matrix of the silicone foam layer, within a pore of the silicone foam layer, or both. A portion of the number of pores in the silicone foam layer can contain the filler composition, or essentially all, or all of the pores can contain the filler composition. Each pore containing the filler composition can independently be partially filled, essentially fully filled, or fully filled. In an aspect in which particles of the filler composition are large relative to a diameter of the pore, or the pore is essentially or fully filled with a plurality of smaller particles, movement of the particles within the pore can be restricted. In this aspect, the filler composition can be located in the pores during manufacture of the layer (for example, by including the filler composition in the composition used to form the silicone foam layer), or the filler composition can be impregnated into the pores after manufacture of the silicone foam layer using a suitable liquid carrier, vacuum, or other known method.

A combination of different filler compositions, including different types, forms, or placements can be used. For example, a filler composition in particulate form within a pore of the silicone foam layer can be used in combination with a filler composition distributed within the silicone foam layer.

The filler can be in the form of a particulate material. Particles can be of any shape, irregular or regular, for example approximately spherical, discs, fibers, flakes, platelets, rods (solid or hollow), spherical (solid or hollow), or whiskers. In an aspect, most, essentially all, or all, of the particles have a largest dimension less than the thickness of the layer or the pore in which they are located, to provide a smooth surface to the layer. The particular diameters used therefore depend on the location of the particles. Bi-, tri-, or higher multimodal distributions of particles can be used. For example, when filler particles are present within the matrix of the silicone foam layer and within the pores of the silicone foam layer, a bimodal distribution of particles can be present. A multimodal distribution can be a result of using two different particulate materials, or a single material with two or more size modes. In an aspect, the median diameter (which as defined herein can mean equivalent spherical diameter) of each of the particulate fillers can be 0.1 micrometers (μm) to 1 millimeter (mm), or 0.5 to 500 μm, or 1 to 50 μm.

In an aspect, the filler can comprise an inorganic filler. Suitable inorganic fillers can include, for example, a ceramic, a clay, a silicate, a plurality of ceramic or glass microspheres. Specific particulate materials can include alumina, aluminum trihydrate, aluminum nitride, aluminum silicate, barium titanate, beryllia, boron nitride, borates (e.g., zinc borate, sodium borate, and the like, and hydrates thereof), calcium carbonate, clay, kaolin, corundum, magnesia, magnesium hydroxide, glass, mica, nanoclay, quartz, silicon carbide, strontium titanate, talc, titanium dioxide (such as rutile and anatase), wollastonite, and the like, or a combination thereof. In an aspect the filler comprises a flame retardant, such as aluminum trihydrate. In a specific aspect, the inorganic filler can comprise aluminum trihydrate and magnesium hydroxide.

Inorganic fillers can optionally have an exterior surface chemically modified by treatment with a coupling agent. The coupling agent can be a silane or epoxy, for example, an organosilane having, at one end, a group that can react with hydroxyl groups present on the exterior surface of the particulate filler and, on the other end, an organic group that will aid in dispersibility of the particulate filler in a polymer matrix (e.g., the silicone foam). A difunctional silane coupling can have a combination of groups such as vinyl, hydroxy, and amino groups, for example, 3-amino-propyldiethoxy silane. Silane coatings can also minimize water absorption.

In an aspect, the filler composition can be a reactive filler composition, comprising at least one reactive filler. As will be understood from the discussion below, the term “reactive” as used in connection with the filler composition includes both chemical reactions and physical processes such as hydrogen bond breaking and formation. The type and amount of reactive filler composition can be first selected to generate water upon exposure to heat, which can be advantageous if improved thermal properties are desired in addition to sound-absorbing properties. As used herein “generating water” can refer to release of water, for example from a hydrate, or formation of water, e.g., by a chemical reaction process. Furthermore, the water generated can be in the form of a liquid or water vapor. As used herein “water” accordingly includes liquid water, water vapor, or a combination thereof. “Heat” as used herein means temperatures such as 200° C. or higher, or 300° C. or higher, or 500° C. or higher. Without being bound by theory, it is believed that generating water from the reactive filler composition can provide thermal barrier properties by absorbing heat, redistributing heat, or by vaporization of water.

Exemplary reactive fillers can include aluminum trihydrate (also known as aluminum trihydroxide or ATH), ammonium nitrate, sodium borate, hydrous sodium silicate, magnesium hydroxide, magnesium carbonate hydroxide pentahydrate, magnesium phosphate tribasic octahydrate, zinc borate, a superabsorbent polymer, or waterglass. Sodium borate is available from manufacturers such as SAE Manufacturing Specialties Corp., Surepure Chemetals, Inc., Mil-Spec Industries, Noah Chemicals, ProChem, Inc., Rose Mill Co., U.S. Borax, Quality Borate, and Barite World. Zinc borate is available from manufacturers such as SAE Manufacturing Specialties Corp., Surepure Chemetals, Inc., Mil-Spec Industries, Noah Chemicals, ProChem, Inc., Rose Mill Co., U.S. Borax, Quality Borate, and Barite World. ATH is available from manufacturers such as SAE Manufacturing Specialties Corp., Surepure Chemetals, Inc., Mil-Spec Industries, USALCO, LLC, Cimbar Perfromance Metals, Huber Engineered Materials, LKAB Minerals, MarkeTech International, R. J. Marshall Company, Aluchem, and Alcan Chemicals.

In an aspect, the sound-absorbing material can comprise at least two fillers having specific properties. In an aspect, the filler composition can comprise at least two of aluminum trihydrate, ammonium nitrate, sodium borate, hydrous sodium silicate, magnesium hydroxide, magnesium carbonate hydroxide pentahydrate, magnesium phosphate tribasic octahydrate, zinc borate, a superabsorbent polymer, or waterglass. In a specific aspect, the filler composition comprises aluminum trihydrate and magnesium hydroxide. It is to be understood that hydrated mineral fillers and waterglass can be represented by different chemical formulas, and the foregoing are inclusive of the various formulas.

Fillers that can participate in formation of a thermal barrier layer, absorb water, or both include various sodium, silicon- and boron-containing mineral fillers. A single filler can both generate water and participate in formation of the thermal barrier layer. Exemplary fillers of this type can include ATH, ammonium nitrate, sodium borate, hydrous sodium silicate, magnesium hydroxide, magnesium carbonate hydroxide pentahydrate, magnesium phosphate tribasic octahydrate, zinc borate, a superabsorbent polymer, or a combination thereof.

In an aspect, the reactive filler composition can be further be formulated to absorb water that can be trapped or released (recycled). In this aspect, the absorption of water provides an additional mechanism to delay, reduce, or block convective heat transport. In this aspect, the reactive filler composition includes a filler that generates water upon exposure to heat and a filler that can absorb the generated water. The water can be permanently absorbed (i.e., trapped), or releasably absorbed (desorbed), allowing recycling of the water. In this aspect, the filler that generates water can include sodium borate, zinc borate, ATH, magnesium hydroxide pentahydrate (MDH), or a combination thereof.

A filler that can absorb the generated water includes superabsorbent polymer (SAP). Under some conditions the SAP absorbs and traps water, where the trapped water is only released by decomposition of the SAP. Under other conditions the SAP can absorb and release water without decomposition of the SAP. Superabsorbent polymers are known in the art, such as the hydrolyzed product of starch grafted with acrylonitrile homopolymer or copolymer, such as a hydrolyzed starch-polyacrylonitrile); starch grafted with acrylic acid, acrylamide, polyvinyl alcohol (PVA) or a combination thereof, such as starch-g-poly(2-propencamide-co-2-propenoic acid, sodium salt); hydrolyzed starch-polyacrylonitrile ethylene-maleic anhydride copolymer; cross-linked carboxymethylcellulose; acrylate homopolymers and copolymers thereof such as a poly(sodium acrylate) and a poly(acrylate-co-acrylamide), specifically a poly(sodium acrylate-co-acrylamide); hydrolyzed acrylonitrile homopolymers; homopolymers and copolymers of 2-procnoic acid, such as poly(2-propenoic acid, sodium salt) and poly(2-propencamide-co-2-propenoic acid, sodium salt) or poly(2-propencamide-co-2-propenoic acid, potassium salt); a cross-linked modified polyacrylamide; a polyvinyl alcohol copolymer, a cross-linked polyethylene oxide; and the like. A combination of two or more different SAPs can be used.

The SAP is preferably an electrolyte, such as a salts of poly(acrylate), for example poly(sodium acrylate). The SAP can have a swelling ratio of 15:1 to 1000:1. Higher ratios are preferred. Upon absorbing water, the SAP traps the water and expands. The expansion can act as a normal force against the adjacent expanding battery cell, which can decrease or prevent damage caused by an expanding cell that has entered thermal runaway.

The SAP can optionally be hydrated with water (via spraying, dipping, or other method) in water. For example, the SAP can be hydrated before being incorporated into the silicone foam, or the silicone foam with the SAP can be immersed in water at room temperature water for 24 hours.

Another filler that can be used to absorb water is waterglass. As is known in the art, waterglass is soluble in water, and comprises sodium oxide (Na₂O) and silicon dioxide (silica, SiO₂). Under some conditions, the waterglass can absorb water to trap it, or absorb water and release it.

In still another aspect, the reactive filler composition can be formulated to produce waterglass in situ, without decomposition of the flexible silicone layer. In this aspect, the fillers can include sodium borate and hydrous sodium silicate. Other components can be present, such as aluminum trihydrate, magnesium hydroxide, magnesium carbonate hydroxide pentahydrate, or ammonium nitrate, or the like, or a combination thereof. Without being bound by theory, it is believed that heat is diffused into the silicone foam, generating water at a variety of temperatures depending on the combination of water generating fillers used. The remaining ions from the decomposition of the water generating filler can form a Lewis acid or a Lewis base, and react with the hydrous sodium silicate to form waterglass. The water can be released to be recycled.

The filler composition can be present in the sound-absorbing material in an amount of 10 to 70 weight percent, based on the total weight of the sound-absorbing material. Within this range, filler composition can be present in an amount of 20 to 60 weight percent, or 20 to 50 weight percent, each based on the total weight of the sound-absorbing material.

The curable composition can further comprise a blowing agent. In an aspect, the blowing agent comprises a chemical blowing agent. For example, in an aspect, the blowing agent can comprise water or a C₁₋₁₂ monoalcohol (which includes diols, triols, carbinols, and the like). In an aspect, the alcohol preferably comprises a C₁₋₆ alcohol. In a specific aspect, the alcohol comprises 1-butanol. In an aspect, the alcohol may consist of a monoalcohol. In an aspect, the blowing agent can comprise or consist of water.

Suitable blowing agents can also include physical blowing agents. These blowing agents can be chosen from a broad range of materials, including hydrocarbons, ethers, esters and partially halogenated hydrocarbons, ethers and esters, or the like. Examples of physical blowing agents have a boiling point from −50 to 100° C., or from −50 to 50° C. Exemplary hydrocarbon and substituted (e.g., halogenated hydrocarbons) can include, for example, HCFC's (halo chlorofluorocarbons) such as 1,1-dichloro-1-fluoroethane, 1,1-dichloro-2,2,2-trifluoro-ethane, monochlorodifluoromethane, and 1-chloro-1,1-difluoroethane; the HFCs (halo fluorocarbons) such as 1,1,1,3,3,3-hexafluoropropane, 2,2,4,4-tetrafluorobutane, 1,1,1,3,3,3-hexafluoro-2-methylpropane, 1,1,1,3,3-pentafluoropropane, 1,1,1,2,2-pentafluoropropane, 1,1,1,2,3-pentafluoropropane, 1,1,2,3,3-pentafluoropropane, 1,1,2,2,3-pentafluoropropane, 1,1,1,3,3,4-hexafluorobutane, 1,1,1,3,3-pentafluorobutane, 1,1,1,4,4,4-hexafluorobutane, 1,1,1,4,4-pentafluorobutane, 1,1,2,2,3,3-hexafluoropropane, 1,1,1,2,3,3-hexafluoropropane, 1,1-difluoroethane, 1,1,1,2-tetrafluoroethane, (Z)-1,1,1,4,4,4-hexafluoro-2-butene, and pentafluoroethane; the HFE's (halo fluoroethers) such as methyl-1,1,1-trifluoroethylether and difluoromethyl-1,1,1-trifluoroethylether; and the hydrocarbons such as n-pentane, isopentane, and cyclopentane. In an aspect, the blowing agent can comprise carbon dioxide, nitrogen, argon, water, air, nitrogen, and inert gases (such as helium and argon), as well as combinations thereof. In an aspect, the blowing agent can comprise carbon dioxide, for example solid carbon dioxide (i.e., dry ice), liquid carbon dioxide, gaseous carbon dioxide, or supercritical carbon dioxide.

In an aspect, water can be included in an amount of 0.01 to 1 weight percent, based on the total weight of the curable composition.

The curable composition can optionally further comprise an inhibitor. Inhibitors suitable for use in the curable composition can include alkenyl-diterminated polyorganosiloxanes which can be represented by the formula:

MₐD_{b}T_{c}Q_{d},
as already discussed above. The function as an inhibitor, the alkenyl-diterminated polyorganosiloxane inhibitor can have a vinyl content of greater than or equal to 15 weight percent (based on the total weight of the alkenyl-diterminated polyorganosiloxane inhibitor), a molecular weight of less than 500 grams per mole (g/mol), or both. In an aspect, the inhibitor is present an comprises an alkenyl-diterminated polyorganosiloxane having have a vinyl content of greater than or equal to 15 weight percent, for example 15 to 40 weight percent, or 20 to 40 weight percent, or 25 to 35 weight percent, and a molecular weight of less than 500 g/mol, for example 50 to 450 g/mol, or 100 to 400 g/mol, or 100 to 250 g/mol.

When present, the inhibitor can be included in the curable composition in an amount of 0.05 to 0.5 weight percent, based on a total weight of the alkenyl-containing component and the hydride-containing component in the curable composition.

Other additives can be present in either part of the curable compositions (as discussed herein), for example, an ultraviolet (UV) stabilizer, antistatic agent, dye, pigment, antimicrobial or antiviral agent, and the like, or a combination thereof. When additives are present, the amounts used are selected so that the desired properties of the cured silicone composition are not adversely affected by the presence of the additives.

The inventors hereof have found that it can be further advantageous to include a methylolated melamine formaldehyde or a phenol-formaldehyde resole in the curable composition. Accordingly, in an aspect, the curable composition can optionally further comprise a methylolated melamine formaldehyde or a phenol-formaldehyde resole. It is noted that the methylolated melamine formaldehyde or a phenol-formaldehyde resole included in the curable composition are precursors to a cured methylolated melamine formaldehyde resin or a cured phenol-formaldehyde resole resin. The methylolated melamine formaldehyde can have the formula

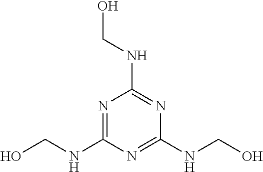 [SMILES: OCNc1nc(NCO)nc(NCO)n1]

and the phenol-formaldehyde resole can have the formula

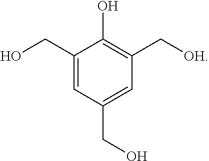 [SMILES: OCc1cc(CO)c(O)c(CO)c1]

Exemplary methods for the manufacture of methylolated melamine formaldehyde and phenol-formaldehyde resole are described in the working examples below. The methylolated melamine formaldehyde or phenol-formaldehyde resole can be included in the curable composition in an amount of 0.05 to 10 weight percent, based on the total weight of the curable composition. Within this range, the methylolated melamine formaldehyde or phenol-formaldehyde resole can be present in the curable composition in an amount of 0.05 to 5 weight percent, or 0.1 to 10 weight percent, or 0.1 to 5 weight percent, or 0.1 to 2.5 weight percent, or 0.1 to 1.5 weight percent, each based on the total weight of the curable composition. In an aspect, the methylolated melamine formaldehyde can be present in an amount of 0.1 to 5 weight percent, or 0.1 to 1 weight percent, or 0.1 to 0.75 weight percent, based on the total weight of the curable composition. In an aspect, the phenol-formaldehyde resole can be present in an amount of 0.05 to 2 weight percent, or 0.06 to 1.5 weight percent, or 0.07 to 0.1.1 weight percent, based on the total weight of the curable composition.

In an aspect, other components not specifically described herein can be minimized (i.e., present in an amount of less than or equal to 5 weight percent, or less than or equal to 1 weight percent, or less than or equal to 0.5 weight percent, or less than or equal to 0.1 weight percent, or less than or equal to 0.01 weight percent, each based on the total weight of the curable composition) or excluded from the curable composition and the cured products (e.g., silicone foams) prepared from the curable compositions. For example, the curable composition can optionally minimize or exclude polymers other than the various polyorganosiloxanes described herein. In an aspect, the curable composition can optionally minimize or exclude surfactants such as fluorinated surfactants. The curable composition or the process of manufacturing the silicone foams described herein can optionally minimize or exclude physical blowing agents.

The silicone foam of the present disclosure can be formed by providing the curable composition and curing the composition. The cured silicone foams described herein are considered as free-standing silicone foams. Free-standing as used herein means that no supporting layers are present. Thus, any discussion of particular properties associated with the cured silicone foams according to the present disclosure will be understood to refer to the properties of the foam layer itself, in the absence of any supporting layers.

In an aspect, the method of making the open-cell, filled silicone foam for use as a sound-absorbing material comprises curing a curable composition in the presence of methylolated melamine formaldehyde to provide the silicone foam, preferably wherein the methylolated melamine formaldehyde is present in an amount of 0.1 to 10 weight percent, based on the total weight of the curable composition.

In an aspect, the method of making the open-cell, filled silicone foam for use as a sound-absorbing material comprises curing a curable composition in the presence of phenol-formaldehyde resole to provide the silicone foam, preferably wherein the phenol-formaldehyde resole is present in an amount of 0.05 to 10 weight percent, based on the total weight of the curable composition.

Without wishing to be bound by theory, it is believed that the presence of methylolated melamine formaldehyde or phenol-formaldehyde resole in the foam can result in increased openness of the foam due to the phenolic rings of the respective chemical structures. It is believed that the presence of the methylolated melamine formaldehyde or phenol-formaldehyde resole can slow the kinetics of the curing reaction, leading to a softer, more open foam. Additionally, the storage modulus of the cured foams is lower compared to a foam not including methylolated melamine formaldehyde or phenol-formaldehyde resole, which can also contribute to softer, more open foams.

In an aspect, the method of making the open-cell, filled silicone foam for use as a sound-absorbing material comprises curing a curable composition having a molar ratio of hydride groups to a sum of alkenyl and hydroxyl groups of 1.1 to 1.5 to provide the silicone foam.

The curable composition can be provided by mixing an alkenyl-containing component comprising an alkenyl-containing polyorganosiloxane; a hydride-containing component comprising a hydride-substituted polyorganosiloxane; a cure catalyst; a filler composition; a blowing agent; and optionally, methylolated melamine formaldehyde or phenol-formaldehyde resole to provide the curable composition. The curable composition can be dispensed into a suitable container and cured under conditions effective to provide the foam. For example, the composition can be cured at a temperature of 20 to 30° C., and post-cured, for example in an oven. Temperatures in the oven can be greater than 100° C., or 100 to 200° C., or 100 to 150° C., and residence time in the oven can be varied to achieve the desired level of cure.

To obtain the advantageous sound-absorbing properties, a particular combination of density, porosity, and cell size is provided, as described in greater detail herein.

The silicone foam is an open-cell silicone foam. As used herein, “open-cell” manes that at least a portion of the pores are interconnected and at least a portion of the pores are open, allowing passage of air, water, water vapor, or the like from a first outer surface of the foam to a second opposite surface of the foam. Preferably, the foam is a substantially open-cell foam, or a completely open-cell foam.

In particular, the open-cell, filled silicone foam has a density of less than 155 kilograms per cubic meters (kg/m³). In an aspect, the open-cell, filled silicone foam can have a density of less than 153 kg/m³, or 100 to less than 155 kg/m³, or 120 to less than 155 kg/m³, or 125 to less than 155 kg/m³, or 130 to less than 155 kg/m³.

The open-cell, filled silicone foam has a porosity of at least 70%. In an aspect, the open-cell, filled silicone foam can have a porosity of 70 to 99%, or 75 to 99%, or 80 to 99%, or 90 to 99%, or 75 to 80%, or 80 to 90%.

Advantageously, the open-cell, filled silicone foam has pores which are anisotropic. An average cell size in a direction parallel to the rise direction of the foam is less than 2300 μm. In an aspect, the average cell size in a direction parallel to the rise direction of the foam can be 1000 to less than 2300 μm, or 1000 to 2250 μm, or 1200 to 2250 μm. An average cell size in a direction perpendicular to the rise direction of the foam is less than 800 μm. In an aspect, the average cell size in a direction perpendicular to the rise direction of the foam can be 400 to less than 800 μm, or 450 to 785 μm, or 475 to 780 μm. Cell size can be determined, for example, using imaging techniques such as optical microscopy.

When cured in the presence of methylolated melamine formaldehyde or phenol-formaldehyde resole resin, the resulting silicone foam can further comprise a residue of methylolated melamine formaldehyde or a residue of a phenol-formaldehyde resole, respectively. The term “residue” as used herein refers to a moiety that is the resulting product of the methylolated melamine formaldehyde or phenol-formaldehyde resole with another component of the curable composition, and further may encompass unreacted methylolated melamine formaldehyde or phenol-formaldehyde resole that may be present in the cured foam.

When present, the residue of methylolated melamine formaldehyde or of a phenol-formaldehyde resole can be present in the foam in an amount of 10 weight percent or less, based on the total weight of the foam. Within this range, the methylolated melamine formaldehyde residue or phenol-formaldehyde resole residue can be present in the foam in an amount of 0.1 to 5 weight percent, or 0.1 to 2.5 weight percent, or 0.1 to 1.5 weight percent, each based on the total weight of the foam.

The present inventors have unexpectedly found that the particular silicone foams according to the present disclosure can provide an advantageous combination of properties, particularly for sound absorbing materials. For example, the sound-absorbing material can have a compression force deflection (CFD) of less than or equal to 3 kilopascals (kPa), or 0.5 to 3 kPa, or 1 to 2.75 kPa, each at 25% deflection. Compression force deflection is determined in accordance with ASTM D1056-20. In an aspect, the sound-absorbing material can exhibit an improvement in acoustical absorption coefficient of at least 5%, or at least 10%, and up to 100%, or up to 85%, or up to 75%, at a frequency in a range of 80 to 500 Hz, relative to a comparative silicone foam not according to the present disclosure (i.e., not having methylolmelamine formaldehyde, not having phenol formaldehyde resole, or not having methylolmelamine formaldehyde, not having phenol formaldehyde resole, and prepared at a ratio of hydride equivalents to the sum of hydroxyl and vinyl equivalents of greater than 1.6:1, or greater than 1.7:1).

This disclosure is further illustrated by the following examples, which are non-limiting.

### Examples

Materials used in the following examples are described in Table 1.

TABLE 1

| Component | Description | Supplier |
|---|---|---|
| Vinyl-terminated | Vinyl-terminated polydimethylsiloxane, having a viscosity of | Elkem |
| PDMS | 100,000 cP, a degree of polymerization of 1850-1900, and a vinyl | |
| | content of 0.04 wt %, obtained as BLUESIL FLD47 | |
| MDQ blend-1 | MDQ resin with vinyl-terminated polydimethylsiloxane carrier, | Momentive |
| | MₓD^{Vi}_{y}Q_{z} / M^{Vi}DₙM^{Vi} blend (24:76 weight ratio of resin to carrier), | |
| | Vi weight of the blend ~0.6%; Viscosity ~62440 cP; Molar ratio | |
| | (x:y:z) = 6.57:1:9.55 | |
| MDQ blend-2 | MDQ resin with vinyl-terminated polydimethylsiloxane carrier, | Momentive |
| | MₓD^{Vi}_{y}Q_{z} / M^{Vi}DₙM^{Vi} blend (24.2:75.8 weight ratio of resin to | |
| | carrier), Vi weight of the blend ~0.64%; Viscosity ~3750 cP; Molar | |
| | ratio (x:y:z) = 7.31:1:10.7 | |
| Pt Catalyst | [1,3-Bis(2,6-diisopropylphenyl)imidazol-2-ylidene][1,3-divinyl- | Umicore |
| | 1,1,3,3-tetramethyldisiloxane]platinum(0), obtained as Umicore | |
| | HS245 Pt catalyst solution (10%) | |
| DI water | Deionized Water | |
| ATH | Aluminum trihydrate, having a mean particle size of 1-3 | Huber |
| | micrometers, obtained as MICRAL 855 | |
| Mg(OH)₂ | Magnesium hydroxide, having a mean particle size of 2-6 | Martin Marietta |
| | micrometers, obtained as MagShield S | Magnesia |
| | | Specialties, |
| | | LLC |
| Hydride | Trimethyl terminated MeHSiO siloxane polymer having pendent | Elkem |
| Polyorganosiloxane-1 | hydride groups and a hydride content of 1.5 wt %, a viscosity of 25 | |
| | cP, obtained as WR-68 | |
| Hydride | Siloxane polymer having pendent and terminal hydride groups and a | Andisil |
| Polyorganosiloxane-2 | hydride content of 0.86 wt % and a viscosity of 50 cP, obtained as | |
| | XL-1342 | |

### Preparation of Methylolated Melamine

Melamine and formaldehyde solution (37% by weight) were purchased from Sigma Aldrich. Tetrahydrofuran (THF) was used as a solvent. An amount of 8 grams (g) (0.064 moles (mol)) of melamine and 15 ml THF were added to a round-bottom flask equipped with a magnetic stirrer. The mixture was heated to 65° C. while stirred constantly. Fifteen milliliters (15 ml, 0.19 mol) of formaldehyde was added and stirred until melamine is completely dissolved, which is recognized by a color change from white suspension to a clear solution. The reaction was continued for another 30 minutes. The clear solution was cooled to room temperature. The solvent was removed in a vacuum oven at 50° C. overnight. The “methylolated” product (uncured) was precipitated out of the solution and was used for further experiments. The experimental procedure was adopted from Polymer Journal (2013) 45, 413-419.

### Preparation of Phenol-Formaldehyde Resole

Phenol, formaldehyde solution (37% by weight), and sodium hydroxide were purchased from Sigma Aldrich. IN solution of sodium hydroxide solution in water was prepared. An amount of 5 g of phenol (0.053 mol) was added to a round-bottom flask and heated to 55° C. to ensure solid-liquid transformation. An amount of 0.5 g of IN NaOH was added to keep the reaction conditions basic. The mixture was heated to 65° C. while stirred constantly. The pH of the solution was checked to ensure it was in the range of 9.5 to 11. An amount of 8.6 ml of formaldehyde solution (0.106 mol of formaldehyde) was added and stirred for 2 hours at 75° C. The reacted material was cooled to room temperature and the excess solvent (water) was removed using a rotovap, followed by heating to 50° C. in a vacuum oven. The “resole material” thus produced was used for further experiments. The experimental procedure was adopted from J Mat Sci (2018) 53:14185-14203.

### Hybrid Silicone/Resole and Silicone/Methylolated Melamine Foam and Characterization

To prepare the Comparative Example, comparative Part A (referred to as “A_{comp}”) and comparative Part B (simply referred to as “Part B”) were first prepared. To prepare A_{comp}, the following mixing procedure was employed: MDQ resin-1 and -2, vinyl-terminated PDMS, and Pt-catalyst were added to an appropriately sized speedmixer cup and mixed at 2000 revolutions per minute (rpm) for 30 seconds (Hauschild SpeedMixer DAC 3000-10000 model, Farmington Hills, MI). ATH and Mg(OH)₂ were added and the formulation was mixed for another 30 seconds at 2500 rpm. To ensure that additives (ATH and Mg(OH)₂) were mixed in entirety with the solution, the formulation was scraped off the walls of the cup into the bulk solution. Weight fractions of the components of A_{comp} are tabulated in Table 2. Part B was made by preparing a stock solution of hydride polyorganosiloxane-1 and -2 (90:10 weight ratio). The two components were added to a speedmixer cup and mixed at 1000 rpm for 20 seconds.

The amounts of various components used to prepare A_{comp} are shown in Table 2. Amounts are shown in weight percent based on the total weight of A_{comp}.

TABLE 2

| Component of A_{comp} | Weight Percent |
|---|---|
| MDQ blend-1 | 49.3% |
| MDQ blend-2 | 8.7% |
| Vinyl-terminated PDMS | 11.97% |
| ATH | 7.5% |
| Mg(OH)₂ | 22.5% |
| Pt Catalyst | 0.028% |

The following mixing protocol was adopted to prepare foam from A_{comp} and Part B. DI water was used as a chemical blowing agent and added at 0.8 wt % of weight of A_{comp} and Part B combined. For a Comparative Example, Part B was 6.7 wt % of A_{comp} and Part B combined. An illustrative calculation is as follows: For 93.3 g of A_{comp}, 6.7 g of Part B is added along with 0.8 g of DI water. The mixing process: 200 g of A_{comp} was taken in a speedmixer cup. An amount of 1.715 g of water was added. The resulting composition was SpeedMixed at 2000 rpm for 15 seconds (referred to as A_{comp} W). For the Comparative Example, 14.36 g of Part B was added to A_{comp} W, and SpeedMixed using the following protocol: 2200 rpm, 2350 rpm, and 2500 rpm for 8 second each. After mixing, the contents of the cup were dispensed in a paper cup and allowed to sit unperturbed for 2 hours. The foam was removed from the paper cup and placed in an oven maintained at 120° C. for 2 hours to post-cure. Upon post-curing the foam was removed and allowed to cool to room temperature. The “dome” of the foam was cut and removed and the remaining foam was used for further characterization.

Compositions of the Comparative Example and Examples 1-6 and the physical properties (density, compression force deflection (CFD) at 25% strain in compression) thereof are shown in Table 3.

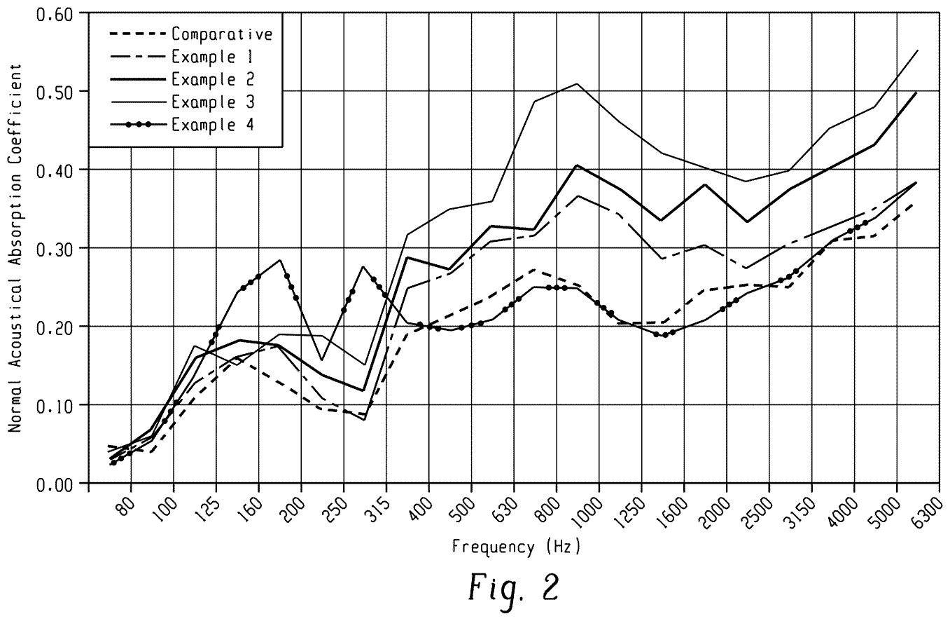

TABLE 3

| | | Comparative | Example | Example | Example | Example | Example | Example |
|---|---|---|---|---|---|---|---|---|
| | Units | Example | 1 | 2 | 3 | 4 | 5 | 6 |
| Composition | | | | | | | | |
| A_{comp}W | g | 201.71 | 201.71 | 201.71 | 201.71 | 201.71 | 201.71 | 201.71 |
| Methylolmelamine | g | — | — | — | — | 0.9 | — | |
| Resole | g | — | 0.2 | 1.1 | 2.05 | — | — | |
| Part B | g | 14.36 | 14.36 | 14.36 | 14.36 | 14.36 | 11.67 | 9.16 |
| Total | g | 216.07 | 216.27 | 217.07 | 218.07 | 216.96 | 213.37 | 210.88 |
| Ratio¹ | | 1.77 | 1.77 | 1.77 | 1.77 | 1.77 | 1.44 | 1.13 |
| Property | | | | | | | | |
| Density², ASTM | kg/m³ | 160.2 | 148.5 | 142.2 | 131.8 | 147.5 | 151.5 | 148.3 |
| D1056-20 | | | | | | | | |
| CFD, | kPa | 3.2 | 2.5 | 2.1 | 1.3 | 2.6 | 2.5 | 2.2 |
| ASTM D1056-20 | | | | | | | | |
| Average cell size³ | μm | 2475 | No data | 1750 | 1685 | 2220 | 2195 | 1198 |
| parallel to the rise | | | | | | | | |
| direction, optical | | | | | | | | |
| microscopy | | | | | | | | |
| Average cell size³ | μm | 758.4 | No data | 593 | 558 | 774 | 530 | 482 |
| perpendicular to | | | | | | | | |
| the rise direction, | | | | | | | | |
| optical microscopy | | | | | | | | |
| Acoustical | | See FIGS. 1 and 2 | | | | | | |
| absorption⁴ | | | | | | | | |
| ASTM E1050-19 | | | | | | | | |

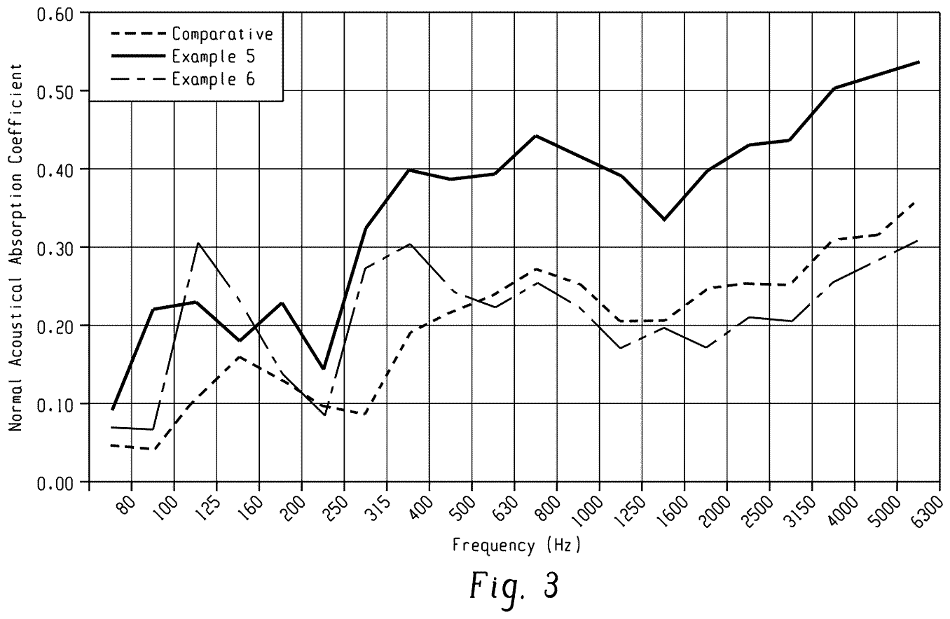

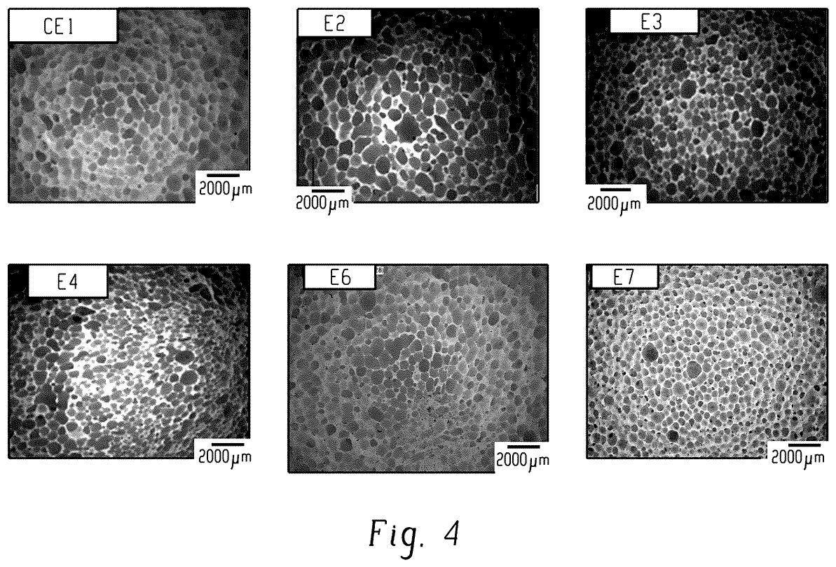

¹Ratio of hydride equivalents to the sum of hydroxyl and vinyl equivalents ([H]/([Vinyl] + [OH]); the —OH from the resole or methylolmelamine were not considered as these were not accurately quantified via NMR or other method;
²Density changes in the rise direction. Average density was measured in the middle of the sample;
³see representative images in FIG. 3, showing cross-sectional optical images of foam perpendicular to the rise direction, and FIG. 4, showing cross-sectional optical images of foam parallel to the rise direction;
⁴sample thickness = 12.5-15 mm, evaluated 3 samples in 100 mm diameter tube (80-1.6 kHz) and 3 samples in 29 mm diameter tube (500-6.4 kHz).

Acoustic properties are further described in Table 4.

TABLE 4

| | Acoustical | | | | | | |
|---|---|---|---|---|---|---|---|
| | absorption | Percent improvement in acoustical absorption coefficient as compared to | | | | | |
| | coefficient of the | the Comparative Example | | | | | |
| Frequency | Comparative | Example | Example | Example | Example | Example | Example |
| (Hz) | Example | 1 | 2 | 3 | 4 | 5 | 6 |
| 80 | 0.05 | −30.4 | −33.7 | −12.8 | −51.2 | 96.5 | 45.1 |
| 100 | 0.04 | 50.1 | 77.5 | 54.9 | 39.1 | 467.8 | 70.9 |
| 125 | 0.11 | 18.2 | 48.2 | 61.9 | 27.9 | 110.1 | 181.5 |
| 160 | 0.16 | 1.8 | 14.3 | −6.0 | 51.1 | 11.0 | 44.6 |
| 200 | 0.13 | 36.0 | 36.3 | 48.0 | 121.1 | 77.2 | 6.2 |
| 250 | 0.09 | 13.3 | 46.8 | 98.6 | 66.3 | 52.4 | −6.9 |
| 315 | 0.09 | −4.5 | 35.2 | 71.8 | 217.4 | 272.4 | 214.8 |
| 400 | 0.19 | 32.4 | 52.3 | 67.6 | 8.4 | 109.9 | 60.4 |
| 500 | 0.22 | 23.3 | 26.0 | 61.7 | −9.9 | 77.6 | 12.6 |
| 630 | 0.24 | 29.8 | 37.9 | 50.6 | −13.0 | 64.3 | −7.0 |
| 800 | 0.27 | 16.9 | 19.6 | 79.6 | −7.2 | 61.9 | −6.1 |
| 1000 | 0.25 | 45.3 | 60.9 | 101.4 | −1.1 | 65.1 | −11.4 |
| 1250 | 0.20 | 68.2 | 85.3 | 127.1 | 1.8 | 91.7 | −16.6 |
| 1600 | 0.21 | 39.2 | 63.5 | 104.8 | −7.9 | 62.5 | −5.0 |
| 2000 | 0.25 | 23.9 | 55.8 | 64.3 | −15.1 | 61.4 | −30.3 |
| 2500 | 0.25 | 9.1 | 32.2 | 52.4 | −3.9 | 69.5 | −16.5 |
| 3150 | 0.25 | 20.8 | 48.7 | 58.3 | 3.5 | 72.7 | −18.8 |
| 4000 | 0.31 | 6.3 | 29.8 | 47.3 | 0.0 | 62.3 | −17.3 |
| 5000 | 0.32 | 11.2 | 37.2 | 52.5 | 7.4 | 64.3 | −10.7 |
| 6300 | 0.36 | 6.5 | 39.0 | 53.4 | 7.0 | 48.7 | −14.1 |

The use of resole in the composition even at a small weight fraction improved the overall sound absorption, particularly at lower frequencies. The benefit in sound absorption is quite distinctive for compositions containing as much as 0.5 wt % of resole. The addition of methylolated melamine to the composition also improves the sound absorption, particularly at the lower frequencies. The ratio of Part A:Part B was also observed to have an impact. Lower ratios up to a point (e.g., a ratio of 1.44:1, Example 5) may be favored for sound absorption. As the ratio is lowered further, sound absorption suffers at higher frequencies (above 500 Hz).

This disclosure further encompasses the following aspects.

Aspect 1: A sound-absorbing material comprising an open-cell, filled silicone foam having a density of less than 155 kg/m³; a porosity of at least 70%; wherein the silicone foam has an average cell size of less than 2300 micrometers, determined in a direction parallel to a rise direction of the foam, and an average cell size of less than 800 micrometers, determined in a direction perpendicular to a rise direction of the foam, each determined by optical microscopy.

Aspect 2: The sound-absorbing material of aspect 1, wherein the open-cell, filled silicone foam comprises a residue of methylolated melamine formaldehyde, preferably wherein the residue of methylolated melamine formaldehyde is present in an amount of less than 10 weight percent, based on the total weight of the foam.

Aspect 3: The sound-absorbing material of aspect 1, wherein the open-cell, filled silicone foam comprises a residue of a phenol-formaldehyde resole, preferably wherein the residue of phenol-formaldehyde resole is present in an amount of less than 10 weight percent, based on the total weight of the foam.

Aspect 4: The sound-absorbing material of any of aspects 1 to 3, wherein the foam is prepared from a curable composition comprising: an alkenyl-containing component comprising an alkenyl-containing polyorganosiloxane; a hydride-containing component comprising a hydride-substituted polyorganosiloxane; a cure catalyst; a filler composition; a blowing agent; and optionally, methylolated melamine formaldehyde or phenol-formaldehyde resole.

Aspect 5: The sound-absorbing material of any of aspects 1 to 4, wherein the open-cell, filled silicone foam comprises a filler composition comprising an inorganic filler.

Aspect 6: The sound-absorbing material of any of aspects 1 to 5, wherein the open-cell, filled silicone foam comprises a filler composition comprising aluminum trihydrate and magnesium hydroxide.

Aspect 7: The sound-absorbing material of any of aspects 1 to 6, comprising 10 to 70 weight percent, or 20 to 60 weight percent, or 20 to 50 weight percent of a filler composition, based on the total weight of the curable composition.

Aspect 8: The sound-absorbing material of any of aspects 4 to 7, wherein the alkenyl-containing component comprises: a first polyorganosiloxane comprising an alkenyl-diterminated polyorganosiloxane comprising a vinyl-diterminated polydimethysiloxane, preferably having a viscosity of greater than 10,000 centipoise, preferably a viscosity of 50,000 to 150,000 centipoise; and a second polyorganosiloxane comprising an alkenyl-substituted MDQ polyorganosiloxane.

Aspect 9: The sound-absorbing material of aspect 8, wherein the alkenyl-substituted MDQ polyorganosiloxane comprises a vinyl-substituted MDQ resin having a vinyl content of 1 to 2.5 weight percent, preferably 2 to 2.5 weight percent.

Aspect 10: The sound-absorbing material of aspect 8 or 9, wherein the alkenyl-substituted MDQ is provided in a carrier fluid comprising a third polyorganosiloxane comprising an alkenyl-diterminated polyorganosiloxane having an alkenyl content of 0.01 to 0.5 weight percent, and a number average molecular weight of 25,000 to 35,000 grams per mole, 65,000 to 75,000 grams per mole, or a combination thereof.

Aspect 11: The sound-absorbing material of any of aspects 4 to 10, wherein the cure catalyst comprises platinum, preferably wherein the cure catalyst is used in an amount of 10 to 40 ppm.

Aspect 12: The sound-absorbing material of any of aspects 4 to 11, wherein the blowing agent comprises water, preferably in an amount 1 weight percent or less, based on the total weight of the curable composition.

Aspect 13: The sound-absorbing material of any of aspects 4 to 12, wherein the curable composition comprises a molar ratio of hydride groups to a sum of alkenyl and hydroxyl groups of greater than or equal to 0.8:1 to less than or equal to 3, or 1:1 to 2:1, or 1.1:1 to 1.8:1, or 1.2:1 to 1.7:1, or 1.1:1 to 1.5:1, or 1.3:1 to 1.5:1.

Aspect 14: The sound-absorbing material of any of aspects 4 to 13, wherein the alkenyl-containing component and the hydride-containing component are present in a weight ratio of alkenyl-containing component:hydride-containing component of 10:1 to 30:1, or 13:1 to 30:1, or 13:1 to 25:1, or 13:1 to 20:1.

Aspect 15: The sound-absorbing material of any of aspects 1 to 14, made by a method comprising curing a curable composition comprising: an alkenyl-containing component comprising an alkenyl-containing polyorganosiloxane; a hydride-containing component comprising a hydride-substituted polyorganosiloxane; a cure catalyst; a filler composition; a blowing agent; and optionally, methylolated melamine formaldehyde or phenol-formaldehyde resole; to provide the sound-absorbing material.

Aspect 16: The sound-absorbing material of any of aspects 1 to 15, wherein the sound-absorbing material has a compression force deflection of less than or equal to 3 kilopascals, or 0.5 to 3 kilopascals, or 1 to 2.75 kilopascals at 25% deflection.

Aspect 17: A method of making an open-cell, filled silicone foam for use as a sound-absorbing material, the method comprising curing a curable composition in the presence of methylolated melamine formaldehyde to provide the silicone foam, preferably wherein the methylolated melamine formaldehyde is present in an amount of 0.1 to 5 weight percent, or 0.1 to 1 weight percent, or 0.1 to 0.75 weight percent, based on the total weight of the curable composition; or phenol-formaldehyde resole to provide the silicone foam, preferably wherein the phenol-formaldehyde resole is present in an amount of 0.05 to 2 weight percent, or 0.06 to 1.5 weight percent, or 0.07 to 0.1.1 weight percent, based on the total weight of the curable composition.

Aspect 18: The method of aspect 17, wherein curing the curable composition is in the presence of the methylolated melamine formaldehyde.

Aspect 19: The method of aspect 17, wherein curing the curable composition is in the presence of the phenol-formaldehyde resole.

Aspect 20: A method of making an open-cell, filled silicone foam for use as a sound-absorbing material, the method comprising curing a curable composition having a molar ratio of hydride groups to a sum of alkenyl and hydroxyl groups of 1.1:1 to 1.5:1 to provide the silicone foam.

Aspect 21: The method of any of aspects 17 to 20, comprising mixing: an alkenyl-containing component comprising an alkenyl-containing polyorganosiloxane; a hydride-containing component comprising a hydride-substituted polyorganosiloxane; a cure catalyst; a filler composition; a blowing agent; and optionally, methylolated melamine formaldehyde or phenol-formaldehyde resole; to provide the curable composition.

Aspect 22: The method of any of aspects 17 to 21, wherein the open-cell, filled silicone foam has a density of less than 155 kg/m³; a porosity of at least 70%; wherein the silicone foam has an average cell size of less than 2300 micrometers, determined in a direction parallel to a rise direction of the foam, and an average cell size of less than 800 micrometers, determined in a direction perpendicular to a rise direction of the foam, each determined by optical microscopy.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. Thus, reference to “an” element in a claim followed by reference to “the” element is inclusive of one element and a plurality of the elements. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A sound-absorbing material comprising an open-cell, filled silicone foam having a density of less than 155 kg/m³;
a porosity of at least 70%;
wherein the silicone foam has
an average cell size of less than 2300 micrometers, determined in a direction parallel to a rise direction of the foam, and
an average cell size of less than 800 micrometers, determined in a direction perpendicular to a rise direction of the foam, each determined by optical microscopy.

2. The sound-absorbing material of claim 1, wherein the open-cell, filled silicone foam comprises a residue of methylolated melamine formaldehyde.

3. The sound-absorbing material of claim 1, wherein the open-cell, filled silicone foam comprises a residue of a phenol-formaldehyde resole.

4. The sound-absorbing material of claim 1, wherein the foam is prepared from a curable composition comprising:
an alkenyl-containing component comprising an alkenyl-containing polyorganosiloxane;
a hydride-containing component comprising a hydride-substituted polyorganosiloxane;
a cure catalyst;
a filler composition;
a blowing agent; and
optionally, methylolated melamine formaldehyde or phenol-formaldehyde resole.

5. The sound-absorbing material of claim 1, wherein the open-cell, filled silicone foam comprises a filler composition comprising an inorganic filler.

6. The sound-absorbing material of claim 1, wherein the open-cell, filled silicone foam comprises a filler composition comprising aluminum trihydrate and magnesium hydroxide.

7. The sound-absorbing material of claim 1, comprising 10 to 70 weight percent of a filler composition, based on the total weight of the curable composition.

8. The sound-absorbing material of claim 4, wherein the alkenyl-containing component comprises:
a first polyorganosiloxane comprising an alkenyl-diterminated polyorganosiloxane comprising a vinyl-diterminated polydimethysiloxane; and
a second polyorganosiloxane comprising an alkenyl-substituted MDQ polyorganosiloxane.

9. The sound-absorbing material of claim 8, wherein the alkenyl-substituted MDQ polyorganosiloxane comprises a vinyl-substituted MDQ resin having a vinyl content of 1 to 2.5 weight percent.

10. The sound-absorbing material of claim 8, wherein the alkenyl-substituted MDQ is provided in a carrier fluid comprising a third polyorganosiloxane comprising an alkenyl-diterminated polyorganosiloxane having an alkenyl content of 0.01 to 0.5 weight percent, and a number average molecular weight of 25,000 to 35,000 grams per mole, 65,000 to 75,000 grams per mole, or a combination thereof.

11. The sound-absorbing material of claim 4, wherein the cure catalyst comprises platinum.

12. The sound-absorbing material of claim 4, wherein the blowing agent comprises water.

13. The sound-absorbing material of claim 4, wherein the curable composition comprises a molar ratio of hydride groups to a sum of alkenyl and hydroxyl groups of greater than or equal to 0.8:1 to less than or equal to 3.

14. The sound-absorbing material of claim 4, wherein the alkenyl-containing component and the hydride-containing component are present in a weight ratio of alkenyl-containing component:hydride-containing component of 10:1 to 30:1.

15. The sound-absorbing material of claim 1, made by a method comprising curing a curable composition comprising:
an alkenyl-containing component comprising an alkenyl-containing polyorganosiloxane;
a hydride-containing component comprising a hydride-substituted polyorganosiloxane;
a cure catalyst;
a filler composition;
a blowing agent; and
optionally, methylolated melamine formaldehyde or phenol-formaldehyde resole;
to provide the sound-absorbing material.

16. The sound-absorbing material of claim 1, wherein the sound-absorbing material has a compression force deflection of less than or equal to 3 kilopascals at 25% deflection.

17. A method of making an open-cell, filled silicone foam for use as a sound-absorbing material, the method comprising curing a curable composition in the presence of
methylolated melamine formaldehyde to provide the silicone foam; or
phenol-formaldehyde resole to provide the silicone foam.

18. The method of claim 17, wherein curing the curable composition is in the presence of the methylolated melamine formaldehyde.

19. The method of claim 17, wherein curing the curable composition is in the presence of the phenol-formaldehyde resole.

20. A method of making an open-cell, filled silicone foam for use as a sound-absorbing material, the method comprising curing a curable composition having a molar ratio of hydride groups to a sum of alkenyl and hydroxyl groups of 1.1:1 to 1.5:1 to provide the silicone foam.

21. The method of claim 17, comprising mixing:
an alkenyl-containing component comprising an alkenyl-containing polyorganosiloxane;
a hydride-containing component comprising a hydride-substituted polyorganosiloxane;
a cure catalyst;
a filler composition;
a blowing agent; and
optionally, methylolated melamine formaldehyde or phenol-formaldehyde resole; to provide the curable composition.

22. The method of claim 17, wherein the open-cell, filled silicone foam has
a density of less than 155 kg/m³;
a porosity of at least 70%;
wherein the silicone foam has
an average cell size of less than 2300 micrometers, determined in a direction parallel to a rise direction of the foam, and
an average cell size of less than 800 micrometers, determined in a direction perpendicular to a rise direction of the foam, each determined by optical microscopy.
